(19) United States
(12) Patent Application Publication
(10) Pub. No.: US 2016/0325382 A1
(43) Pub. Date: Nov. 10, 2016

(54) METHOD FOR PROTECTING A COMPONENT, LASER DRILLING METHOD, AND COMPONENT

(71) Applicant: SIEMENS AKTIENGESELLSCHAFT, München (DE)

(72) Inventors: Christopher Degel, Berlin (DE); Diana Felkel, Berlin (DE); Andrea Massa, Berlin (DE)

(21) Appl. No.: 15/109,520

(22) PCT Filed: Dec. 2, 2014
(86) PCT No.: PCT/EP2014/076226

§ 371 Date: Jul. 1, 2016

(30) Foreign Application Priority Data
Jan. 8, 2014 (DE) 102014200114.5

(51) Int. Cl. B23K 26/382; F01D 5/28; F01D 5/18; B23K 26/18; B23K 26/40

(52) U.S. Cl. CPC B23K 26/389; B23K 26/18; B23K 26/40; F01D 5/186; F01D 5/28; F01D 5/288; B23K 2201/001

(57) ABSTRACT

A method is provided for protecting a component during laser working or working that produces melt phases, particularly during laser drilling, of the component with a cavity, in which a through-hole is introduced through a wall of the cavity of the component, in which the cavity is filled at least in an area of a region to be worked, including introducing a mixture of a water-based liquid mixture containing amino acid into the cavity as a filling.

### CROSS-REFERENCE TO RELATED APPLICATIONS

This application claims priority to PCT Application No. PCT/EP2014/076226, having a filing date of Dec. 2, 2014, based off of German Application No. DE 102014200114.5, having a filing date of Jan. 8, 2014, the entire contents of which are hereby incorporated by reference.

### FIELD OF TECHNOLOGY

The following relates to a laser drilling method, to a corresponding protection method and to a component, in which a filling material is introduced into the hollow component.

### BACKGROUND

High-temperature components such as turbine blades are cooled internally, with air or superheated steam additionally emerging through film cooling holes in order to additionally protect the surface.

Therefore, through-bores have to be introduced into the hollow-cast component. However, the internal structure must not be damaged during the drilling, or not all that much, when the laser beam acts on it as it breaks through into the interior of the hollow component.

Often, a material that is hard at room temperature is heated, fluidized and introduced into the cavity under pressure. This is followed by the laser radiation, with the material then having to be removed again by a laborious, lengthy burning-out process.

### SUMMARY

An aspect relates to solving the aforementioned problem.

### BRIEF DESCRIPTION

Some of the embodiments will be described in detail, with reference to the following figures, wherein like designations denote like members, wherein

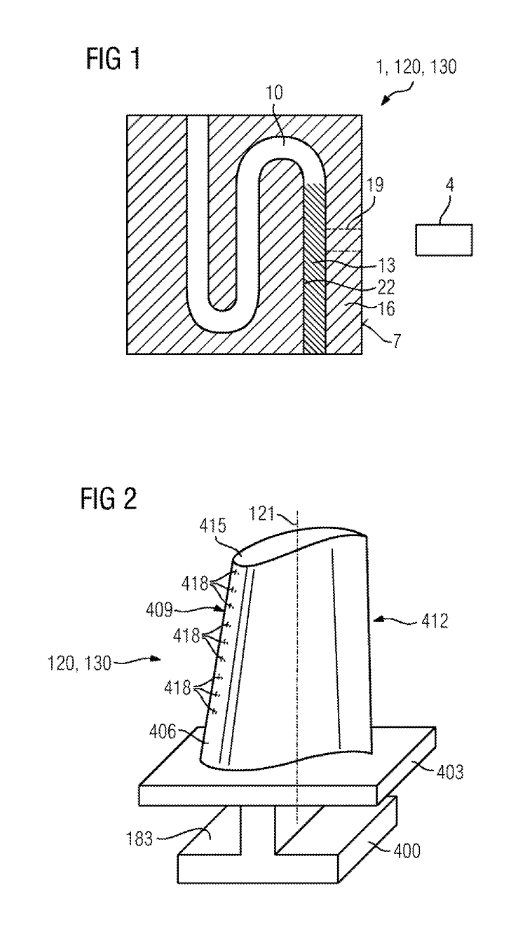

FIG. 1 schematically shows an embodiment of a laser drilling device with a component;

FIG. 2 shows an embodiment of a turbine blade; and

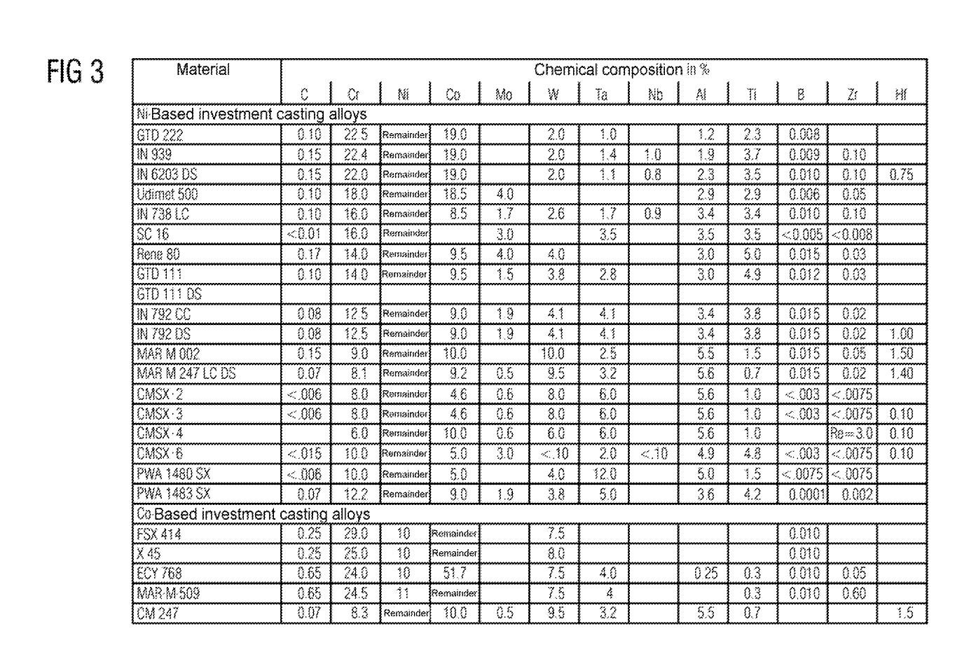

FIG. 3 shows a list of superalloys.

The figures and the description only represent exemplary embodiments of the invention.

### DETAILED DESCRIPTION

Just by way of example of a hollow component 1, FIG. 1 shows a detail of a turbine blade 120, 130 (FIG. 2) of a nickel- or cobalt-based alloy, preferably according to FIG. 3, which has a cavity 10. A through-hole 19 (explained only by way of example below)—indicated by dashed lines—is to be made in particular through a wall 16 of the cavity 10 of the component 1, 120, 130 in the region 19.

This is preferably performed by a laser 4 (or an electron gun), the beam of which removes material from the wall 16, starting from the surface 7. When it breaks through into the cavity 10 of the hollow component 1, 120, 130, the internal structure 22 in the cavity 10 could be damaged.

In order to prevent this, a mixture 13 is introduced into the cavity 10, at least in the region of the through-hole 19 to be produced.

The mixture 13 comprises at least a water-based liquid mixture containing amino acid.

Polysaccharides, most particularly heteropolysaccharides, may preferably be added to the mixture 13.

A salt, most particularly pyruvate, may preferably be added to the mixture 13.

Again preferably, a sulfate may be added to the mixture 13.

Then, before the working is carried out in the component 1, 120, 130, the mixture 13 is heated, preferably at 373 K to 383 K, particularly for 10 min-120 min, most particularly for 90 min.

After the working, particularly the laser drilling, the mixture 13 can be easily removed from the blade 120, 130.

It may be the case that burning out, of a much shorter duration, in a burnout furnace is still necessary.

The mixture 13 acts as protection, so that in respect of a laser method both the percussive method and the trepanning method can be used, in order to produce a high-quality bore 19 and avoid “recasting”.

After producing the holes 19, the mixture 13 can be easily removed. This can be assisted by shaking.

Even meandering cavities 10 are easily accessible.

One application is also that of reopening holes in a component 1, 120, 130, when the component 1, 120, 130 with already drilled through-holes is coated and the cavity 10 is likewise protected.

Clear savings in the time taken by the laser drilling process and in the preparation for the process and reworking are obtained by the embodiment described. Moreover, the quality of the bores increases, since both percussive and trepanning methods can be used.

The advantage here is that the internal space can be completely filled by filling with the mixture, and consequently can be better protected.

FIG. 2 shows in a perspective view a moving blade 120 or stationary blade 130 of a turbomachine, which extends along a longitudinal axis 121.

The turbomachine may be a gas turbine of an aircraft or of a power plant for generating electricity, a steam turbine or a compressor.

The blade 120, 130 has, following one after the other along the longitudinal axis 121, a fastening region 400, an adjoining blade platform 403 and also a blade airfoil 406 and a blade tip 415.

As a stationary blade 130, the blade 130 may have a further platform at its blade tip 415 (not represented).

In the fastening region 400 there is formed a blade root 183, which serves for the fastening of the moving blades 120, 130 to a shaft or a disk (not represented).

The blade root 183 is designed for example as a hammer head. Other designs as a firtree or dovetail root are possible.

The blade 120, 130 has for a medium which flows past the blade airfoil 406 a leading edge 409 and a trailing edge 412.

In the case of conventional blades 120, 130, solid metallic materials, in particular superalloys, are used for example in all the regions 400, 403, 406 of the blade 120, 130.

Such superalloys are known, for example, from EP 1 204 776 B1, EP 1 306 454, EP 1 319 729 A1, WO 99/67435 or WO 00/44949.

The blade 120, 130 may in this case be produced by a casting method, also by means of directional solidification, by a forging method, by a milling method or combinations of these.

Workpieces with a monocrystalline structure or structures are used as components for machines which are exposed to high mechanical, thermal and/or chemical loads during operation.

The production of monocrystalline workpieces of this type takes place for example by directional solidification from the melt. This involves casting methods in which the liquid metallic alloy solidifies to form the monocrystalline structure, i.e. to form the monocrystalline workpiece, or in a directional manner.

Dendritic crystals are thereby oriented along the thermal flow and form either a columnar grain structure (i.e. grains which extend over the entire length of the workpiece and are commonly referred to here as directionally solidified) or a monocrystalline structure, i.e. the entire workpiece comprises a single crystal. In these methods, the transition to globulitic (polycrystalline) solidification must be avoided, since undirected growth necessarily causes the formation of transversal and longitudinal grain boundaries, which nullify the good properties of the directionally solidified or monocrystalline component.

While reference is being made generally to directionally solidified structures, this is intended to mean both mono crystals, which have no grain boundaries or at most small-angle grain boundaries, and columnar crystal structures, which indeed have grain boundaries extending in the longitudinal direction but no transversal grain boundaries. These second-mentioned crystalline structures are also referred to as directionally solidified structures.

Such methods are known from U.S. Pat. No. 6,024,792 and EP 0 892 090 A1.

Similarly, the blades 120, 130 may have coatings against corrosion or oxidation, for example (MCrAlX; M is at least one element of the group comprising iron (Fe), cobalt (Co) and nickel (Ni), X is an active element and represents yttrium (Y) and/or silicone and/or at least one element of the rare earths, or hafnium (Hf)). Such alloys are known from EP 0 486 489 B1, EP 0 786 017 B1, EP 0 412397 B1 or EP 1 306 454 A1.

The density is preferably 95% of the theoretical density.

A protective aluminum oxide layer (TGO=thermal grown oxide layer) forms on the MCrAlX layer (as an intermediate layer or as the outermost layer).

The composition of the layer preferably comprises Co-30Ni-28Cr-8Al-0.6Y-0.7Si or Co-28Ni-24Cr-10Al-0.6Y. Apart from these cobalt-based protective coatings, nickel-based protective coatings are also preferably used, such as Ni-10Cr-12Al-0.6Y-3Re or Ni-12Co-21Cr-11Al-0.4Y-2Re or Ni-25Co-17Cr-10Al-0.4Y-1.5Re.

A thermal barrier coating which is preferably the outermost layer and consists for example of ZrO₂, Y₂O₃—ZrO₂, i.e. is unstabilized, partially stabilized or completely stabilized by yttrium oxide and/or calcium oxide and/or magnesium oxide, may also be present on the MCrAlX.

The thermal barrier coating covers the entire MCrAlX layer.

Columnar grains are produced in the thermal barrier coating by suitable coating methods, such as for example electron-beam physical vapor deposition (EB-PVD).

Other coating methods are conceivable, for example atmospheric plasma spraying (APS), LPPS, VPS or CVD. The thermal barrier coating may have grains which are porous, are provided with microcracks or are provided with macrocracks for better thermal shock resistance. The thermal barrier coating is therefore preferably more porous than the MCrAlX layer.

Refurbishment means that components 120, 130 may have to be freed of protective layers after use (for example by sandblasting). This is followed by removal of the corrosion and/or oxidation layers or products. If need be, cracks in the component 120, 130 are then also repaired. This is followed by recoating of the component 120, 130 and renewed use of the component 120, 130.

The blade 120, 130 may be hollow or of a solid form. If the blade 120, 130 is to be cooled, it is hollow and may also have film cooling holes 418 (indicated by dashed lines).

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements

1. A method for protecting a component during laser working or working that produces melt phases, particularly during laser drilling, of the component with a cavity, in which a through-hole is introduced through a wall of the cavity of the component, in which the cavity is filled at least in an area of a region to be worked, comprising:
Introducing a mixture of a water-based liquid mixture containing amino acid into the cavity as a filling.

2. The method as claimed in claim 1, in which polysaccharides are added to the mixture, and introduced.

3. The method as claimed in claim 1, in which a salt is added to the mixture, and introduced.

4. The method as claimed in claim 1, in which a sulfate is added to the mixture, and introduced.

5. The method as claimed in claim 1, in which the entire cavity is filled with the mixture.

6. The method as claimed in claim 1, in which, before the working is carried out, the mixture is heated at 373 K to 383 K for 10 min-120 min.

7. The method as claimed in claim 1, in which a very short burning-out process is performed after the introduction of the through-holes to remove the material from the cavity.

8. , in which a through-hole is introduced through a wall of the cavity of the component, and a method for protecting the cavity as claimed in claim 1 is used.

9. A hollow component with a mixture as claimed in claim 1 in the cavity.

10. The method as claimed in claim 1, in which heteropolysaccharides are added to the mixture, and introduced.

11. The method as claimed in claim 1, in which pyruvte is added to the mixture, and introduced.

12. The method as claimed in claim 1, in which, before the working is carried out, the mixture is heated at 373 K to 383 K for 90 min.
